(19) United States
(12) Patent Application Publication
(10) Pub. No.: US 2005/0141991 A1
(43) Pub. Date: Jun. 30, 2005

(54) Method for conditioning a compressor airflow and device therefor

(76) Inventor: Hans Ulrich Frutschi, Riniken (CH)

Correspondence Address: COLLIER SHANNON SCOTT, PLLC, 3050 K STREET, NW, SUITE 400, WASHINGTON, DC, 20007, US

(21) Appl. No.: 10/826,325

(22) Filed: Apr. 19, 2004

Related U.S. Application Data
(63) Continuation of application No. PCT/IB02/04068, filed on Oct. 2, 2002.

(30) Foreign Application Priority Data
Oct. 17, 2001 (CH) CH 2001 1909/01

(51) Int. Cl. F03D 7/00

(52) U.S. Cl. 415/144

(57) ABSTRACT

In a method for conditioning a compressor airflow in an axial compressor which comprises in a coaxial arrangement a central rotor and stator surrounding said rotor, an airflow is sucked in at an entrance and is compressed on the way to an exit, whereby the sucked-in airflow is a combination of a main flow and boundary flow which flows adjacent to the inner wall of the stator. Cooling air is taken from the boundary flow at an outlet which is located before the exit. A temperature of the cooling air is reduced in a simple an effective way by injecting water into the boundary flow between the entrance and the outlet. The injected water cools down the boundary flow by evaporation.

### CROSS-REFERENCE TO RELATED APPLICATIONS

This application is a continuation of the U.S. National Stage designation of co-pending International Patent Application PCT/IB02/04068 filed Oct. 2, 2002, the entire content of which is expressly incorporated herein by reference thereto.

### FIELD OF THE INVENTION

The present invention relates to the area of gas turbine technology. In particular, the present invention concerns a process for conditioning a compressor airflow and a device for carrying out the process.

### BACKGROUND OF THE INVENTION

An axial compressor 1, as shown schematically in FIG. 1, comprises a rotor 2 that can rotate around an axis 9, a stator 3, and a number of blade rings that consist alternatively of the running blades 4 mounted on the rotor 2 and guiding vanes 5 mounted on the stator 3. For the sake of simplicity, only one blade of each blade ring is shown in each case.

The axial compressor 1 sucks in air at an entrance, which is compressed in the flow channel formed between the rotor 2 and the inside wall of the stator 3 and exits from the exit 10 under elevated pressure. If the axial compressor is part of a gas turbine system, the compressed air leaving at exit 10 is supplied to a downstream combustion chamber and used there for combustion of a fuel. The pressure of the hot gases that develop is then relieved in a downstream gas turbine with energy output.

The airflow sucked in at entrance 11 can be divided into two flows, namely a main flow A that flows in the center of the flow channel and a boundary flow B that flows along the inside wall of the stator 3. If for cooling purposes air is now taken from an outlet 6 located between entrance 11 and exit 10, this air mainly comes from boundary flow B while main flow A continues to be compressed behind the outlet 6.

The polytropic efficiency of the axial compressor 1 is not constant over the radial extension of the running blades 4 and guiding vanes 5. The central airflow is compressed with a better efficiency than that at the rotor 2 and flow currents lying at the inner wall of the stator 3. The (branched) air removed at outlet 6, therefore, has a significantly higher temperature than the air at location 7 in the central flow.

In a case where the air quantity taken from outlet 6 will be used as cooling air for a gas turbine, this temperature elevation is a disadvantage. Instead of simply carrying out a cooling of this airflow (B), which usually involves a loss of efficiency in the gas turbine system since more fuel is required, it would be desirable, not only to prevent the temperature increase during compression, but even to achieve a temperature reduction of the boundary flow B.

### SUMMARY OF THE INVENTION

Advantageously, the invention provides a process for conditioning a compressor airflow that prevents the disadvantages of known processes, and in a simple and effective manner makes possible a reduction in the temperature of the compressed boundary flow at the outlet, as well as a device for carrying out the process.

Advantageously in the present invention, water is brought into the boundary flow between the entrance and the exit, which evaporates while cooling the boundary flow. Because of this, the boundary flow that is later used as cooling air is cooled without the other functions of the compressor being influenced by this.

Preferably, this is achieved in that the water is brought into the axial compressor in such a way that it forms a thin film of water on the inside of the stator. In particular, the water is sprayed into the boundary flow by several nozzles arranged so that they are distributed around the circumference of the stator.

A preferred design of the device according to the invention is distinguished in that the means for bringing in the water consist of several nozzles that are arranged so that they are distributed on the circumference of the stator.

### BRIEF DESCRIPTION OF THE DRAWINGS

In the following, the invention will be described in more detail using the embodiments in connection with the drawing.

FIG. 1 shows a schematic representation of a preferred embodiment of an axial compressor according to the invention.

### DETAILED DESCRIPTION OF THE PREFERRED EMBODIMENTS

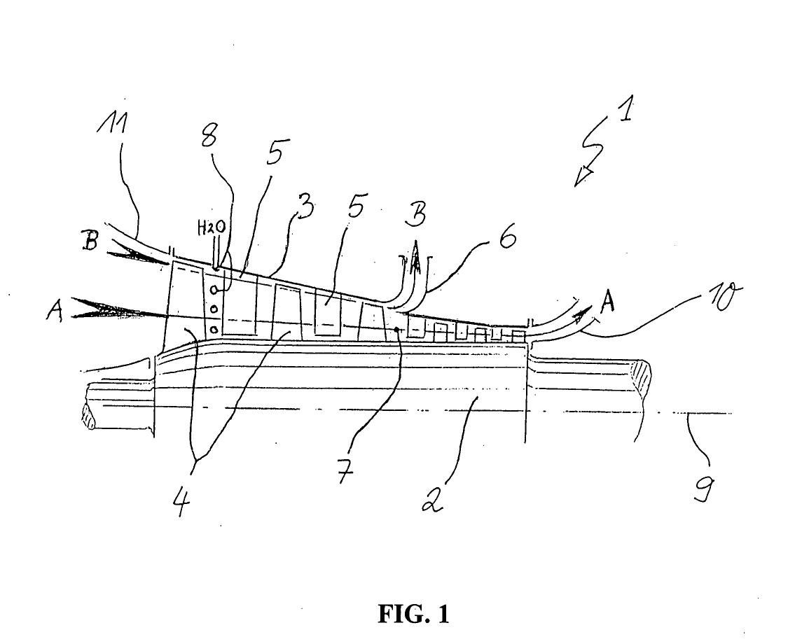

Significant parts and functions of the axial compressor shown in FIG. 1 have already been described in connection with the explanation of the state of the art. According to a preferred embodiment of the invention, in the axial compressor 1, water (H₂O) is supplied into the flow channel between rotor 2 and stator 3 by way of several nozzles 8 arranged on the circumference of the stator 3. The water supplied by way of the nozzles 8 forms a thin film of water on the inside of the stator 3 because of the airflow in the flow channel. This water film is in contact with boundary flow B and evaporated while cooling boundary flow B. The cooled boundary flow B is then available at outlet 6 as cooling air for the downstream gas turbine.

Preferably, the nozzles 8 are arranged between adjacent running blades 4 and guiding vanes 5 so that the water film can be formed well. The cooling effect of the evaporating water film is maximum if the nozzles 8 are additionally arranged in flow direction shortly behind the entrance 11 of the axial compressor 1.

1. A process for conditioning a compressor airflow in an axial compressor comprising an entrance, an exit, a central rotor and a stator surrounding the rotor, with the rotor and stator being coaxially arranged about an axis, in which process the airflow is drawn in at the entrance and compressed along the axis, wherein the drawn in airflow comprises a main flow and a boundary flow lying at an inner wall of the stator, wherein air is taken from the boundary flow at an outlet lying before the exit in flow direction for use as cooling air, and wherein between the entrance and the outlet water is introduced into the boundary flow and evaporates while cooling the boundary flow.

2. The process of claim 1, wherein the water is introduced into the axial compressor so that the water forms a thin water film on the inner wall of the stator.

3. The process of claim 2, wherein the water is sprayed into the boundary flow by a plurality of nozzles arranged proximate the circumference of the stator.

4. A process for conditioning a compressor airflow in an axial compressor comprising an entrance, an exit, a central rotor and a stator surrounding the rotor, with the rotor and stator being coaxially arranged about an axis, the process comprising:
drawing and compressing the airflow from the entrance toward the exit, the airflow comprising a main flow and a boundary flow disposed at an inner wall of the stator;
introducing water into the boundary flow and evaporating the water while cooling the boundary flow;
directing air from the cooled boundary flow out an outlet disposed between the entrance and exit for use as cooling air.

5. The process of claim 4, wherein the water is introduced into the axial compressor so that the water forms a thin film on the inner wall of the stator.

6. The process of claim 5, wherein the water is sprayed into the boundary flow by a plurality of nozzles arranged proximate the circumference of the stator.

7. The process of claim 4, wherein the axial compressor further comprises an alternating arrangement of running blades and guide vanes, and the water is introduced through nozzles disposed between adjacent running blades and guide vanes.

8. The process of claim 7, wherein the nozzles are arranged proximate the entrance of the axial compressor in flow direction.

9. An axial compressor adapted to condition an airflow, the axial compressor comprising:
an entrance, an exit, a central rotor and a stator surrounding the rotor, with the rotor and stator being coaxially arranged about an axis;
means provided on the stator for introducing water into a boundary flow of the airflow disposed at an inner wall of the stator.

10. The axial compressor of claim 9, wherein the means for introducing water comprises a plurality of nozzles circumferentially arranged on the stator.

11. The axial compressor of claim 10, wherein the axial compressor further comprises an alternating arrangement of running blades and guide vanes, and the nozzles are mounted between adjacent running blades and guide vanes.

12. The axial compressor of claim 11, wherein the nozzles are arranged proximate the entrance of the axial compressor in flow direction.

13. The axial compressor of claim 10, wherein the nozzles are arranged proximate the entrance of the axial compressor in flow direction.

14. The axial compressor of claim 10, further comprising an outlet disposed between the nozzles and exit for receiving air from the boundary flow.
